(19) United States
(12) Patent Application Publication
(10) Pub. No.: US 2018/0326751 A1
(43) Pub. Date: Nov. 15, 2018

(54) LIQUID DROPLET DISCHARGING APPARATUS

(71) Applicant: SEIKO EPSON CORPORATION, Tokyo (JP)

(72) Inventors: Masaaki ANDO, Matsumoto-shi (JP); Shinya KOMATSU, Shiojiri-shi (JP); Nobuaki KAMIYAMA, Matsumoto-shi (JP); Kazuhito HORI, Azumino-shi (JP)

(21) Appl. No.: 15/972,308

(22) Filed: May 7, 2018

(30) Foreign Application Priority Data
May 9, 2017 (JP) 2017-092817

(51) Int. Cl. B41J 11/00; B41J 2/165

(52) U.S. Cl. CPC B41J 11/002; B41J 2002/1655; B41J 2/16535; B41J 2/1652

(57) ABSTRACT

A liquid droplet discharging apparatus includes a head, a temporary curing irradiating unit as an irradiating unit, a maintenance unit, and a controller, in which the controller sets a cleaning interval of the nozzle surface by the maintenance unit as a first interval when a first mode, in which an irradiation amount of the ultraviolet rays of the temporary curing irradiating unit with respect to a unit printing area is set as a first amount, is performed, and sets the cleaning interval of the nozzle surface by the maintenance unit as a second interval which is longer than the first interval when a second mode, in which the irradiation amount of the ultraviolet rays of the temporary curing irradiating unit with respect to the unit printing area is set as a second amount which is smaller than the first amount, is performed.

### BACKGROUND

### 1. Technical Field

The present invention relates to a liquid droplet discharging apparatus.

### 2. Related Art

In the related art, a liquid droplet discharging apparatus in which images, letters, or the like are recorded by forming a plurality of dots on a recording medium using an ultraviolet ray curable ink that cures from liquid to solid by being irradiated with ultraviolet rays is known. For example, JP-A-2004-9483 discloses an ink jet recording apparatus (liquid droplet discharging apparatus) including an ultraviolet ray irradiating lamp (irradiating unit) in which the irradiation conditions with ultraviolet rays are changed depending on the difference of a recording medium or a printing mode. It is described that optimal fixing of an ink to a variety of recording media is possible.

In a large-sized liquid droplet discharging apparatus that is used in commercial and industrial uses, there is a demand for improvement in the production efficiency of printed substances.

Meanwhile, in the liquid droplet discharging apparatus in which ultraviolet ray curable ink is used, in order to prevent a discharging defect in a nozzle caused by the reaching of leaked light of ultraviolet rays radiated from an irradiating unit to a nozzle surface formed in the nozzle that discharges liquid droplets and the fixing of the ultraviolet ray curable ink attached to the nozzle surface, the nozzle surface is periodically cleaned. During this cleaning, printing is not performed, which acts as a cause for a decrease in the production efficiency.

However, the nozzle surface is cleaned at predetermined cleaning intervals regardless of the types of recording media or the printing mode, and thus, in the liquid droplet discharging apparatus of JP-A-2004-9483 in which only the irradiation conditions of ultraviolet rays are changed, it is difficult to improve the production efficiency.

### SUMMARY

The invention can be realized in the following aspects or application examples.

### APPLICATION EXAMPLE 1

According to this application example, there is provided a liquid droplet discharging apparatus including a head that discharges an ultraviolet ray curable ink, an irradiating unit that irradiates the ultraviolet ray curable ink landed on a recording medium with ultraviolet rays, a cleaning unit that cleans a nozzle surface of the head, and a controller, in which the controller sets a cleaning interval of the cleaning unit with respect to the nozzle surface as a first interval when a first mode, in which an irradiation amount of the ultraviolet rays of the irradiating unit with respect to a unit printing area is set as a first amount, is performed, and sets the cleaning interval of the cleaning unit with respect to the nozzle surface as a second interval which is longer than the first interval when a second mode, in which the irradiation amount of the ultraviolet rays of the irradiating unit with respect to the unit printing area is set as a second amount which is smaller than the first amount, is performed.

In this configuration, the controller of the liquid droplet discharging apparatus sets the cleaning interval of the nozzle surface as the second interval which is smaller than the first interval of the first mode, when printing is performed in the second mode in which the irradiation amount of the ultraviolet rays is set as the second amount which is smaller than the first amount of the first mode. In a case of the second mode, energy of the leaked light reaching the nozzle surface in the first mode is also reduced, and thus a time until the ultraviolet ray curable ink attached to the nozzle surface is fixed so as to cause a discharging defect of liquid droplets is also longer. Therefore, the controller sets the cleaning interval of the nozzle surface in the second mode to be longer than that in the first mode, that is, the number of times of cleaning is reduced, and thereby making it possible to improve the production efficiency of the liquid droplet discharging apparatus.

### APPLICATION EXAMPLE 2

According to this application example, there is provided a liquid droplet discharging apparatus including a head that discharges an ultraviolet ray curable ink, an irradiating unit that irradiates the ultraviolet ray curable ink landed on a recording medium with ultraviolet rays, a cleaning unit that cleans a nozzle surface of the head, an input unit, and a controller, in which the controller sets an irradiation amount of the ultraviolet rays by the irradiating unit based on an input value which is input through the input unit, sets a cleaning interval of the cleaning unit with respect to the nozzle surface as a first interval when the irradiation amount of the ultraviolet rays of the irradiating unit with respect to the unit printing area is set as a first amount, and sets the cleaning interval of the cleaning unit with respect to the nozzle surface as a second interval which is longer than the first interval when the irradiation amount of the ultraviolet rays of the irradiating unit with respect to the unit printing area is set as a second amount which is smaller than the first amount.

In this configuration, the controller of the liquid droplet discharging apparatus sets the cleaning interval of the nozzle surface as the second interval which is longer than the first interval at the time of performing the printing in the first amount, based on the input value through the input unit, when the printing is performed by a second amount in which the irradiation amount of the ultraviolet rays is smaller than the first amount. In a case in which the printing is performed by the second amount, energy of the leaked light which reaches the nozzle surface is also reduced by the printing performed by the first amount, and the time until the ultraviolet ray curable ink attached to the nozzle surface is cured so as to cause the discharging defect of the liquid droplets is also longer. Therefore, the controller sets the cleaning interval of the nozzle surface at the time of performing the printing by the second amount to be longer than the first interval at the time of performing the printing by the first amount, that is, the number of times of cleaning is reduced, and thereby making it possible to improve the production efficiency of the liquid droplet discharging apparatus.

### APPLICATION EXAMPLE 3

In the liquid droplet discharging apparatus according to the application example, it is preferable that a product of the first amount and the first interval be equal to a product of the second amount and the second interval.

In this configuration, the product of the first amount and the first interval is an accumulated light amount of the ultraviolet rays radiated from the irradiating unit until the cleaning is performed. Since the product of the second amount and the second interval is equal to the product of the first amount and the first interval, the accumulated light amount of the ultraviolet rays radiated by the second amount is equal to the accumulated light amount of the ultraviolet rays radiated by the first amount. In other words, since respective accumulated light amount of the leaked light reaching the nozzle surface is also equal to another, in a case in which printing is performed by the second amount with the second interval, it is possible to reduce the number of times of cleaning while maintaining probability of generation (frequency) of the discharging defect caused by the curing of an ultraviolet ray curable ink to be equal to probability of generation when printing is performed by the first amount with the first interval.

### APPLICATION EXAMPLE 4

In the liquid droplet discharging apparatus according to the application example, it is preferable that the irradiating unit include a temporary curing irradiating unit and a final curing irradiating unit, and the controller set the cleaning interval based on the irradiation amount of the temporary curing irradiating unit with respect to the unit printing area.

In this configuration, the ultraviolet ray curable ink discharged to the recording medium is temporarily cured by being irradiated from the temporary curing irradiating unit immediately after being landed on the recording medium. That is, since the head and the temporary curing irradiating unit are disposed close to each other, and the cleaning interval is set based on the irradiation amount of the temporary curing irradiating unit, it is possible to obtain an appropriate second interval.

### BRIEF DESCRIPTION OF THE DRAWINGS

The invention will be described with reference to the accompanying drawings, wherein like numbers reference like elements.

FIG. 1 is a front view schematically exemplifying a configuration of a liquid droplet discharging apparatus according to an embodiment.

FIG. 2 is perspective view exemplifying an exterior of the liquid droplet discharging apparatus.

FIG. 3 is an enlarged front view illustrating details of heads and irradiating units.

FIG. 4 is a plan view describing a movement mode of a head unit.

FIG. 5 is a side view describing the movement mode of the head unit.

FIG. 6 is an electrical block diagram illustrating an electrical configuration of the liquid droplet discharging apparatus.

FIG. 7 is a setting table illustrating a relationship of a printing mode, an irradiation amount, and a cleaning interval.

### DESCRIPTION OF EXEMPLARY EMBODIMENTS

Hereinafter, an embodiment of the invention will be described with reference to drawings. Also, regarding each drawing to be described later, since each member or the like is illustrated in size to be recognizable, a size of each member or the like is illustrated different from the actual size thereof.

### Embodiment

### Outline Configuration of Liquid Droplet Discharging Apparatus

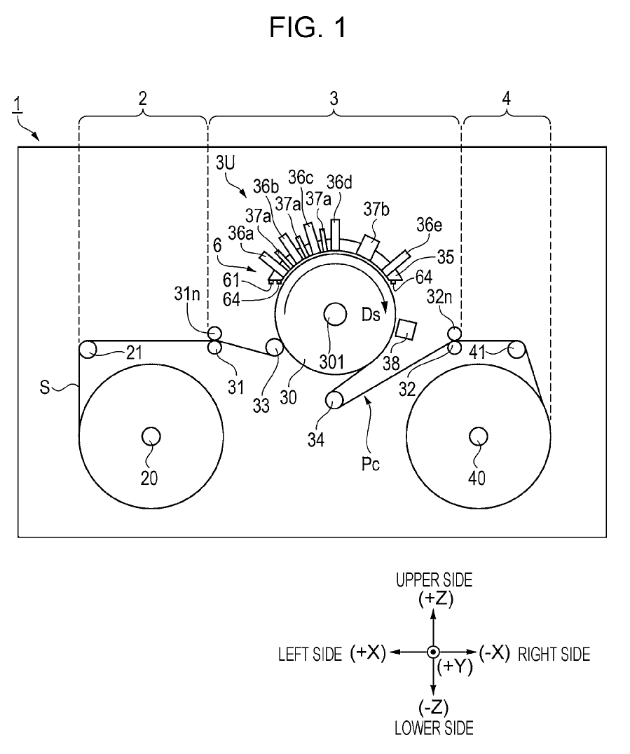

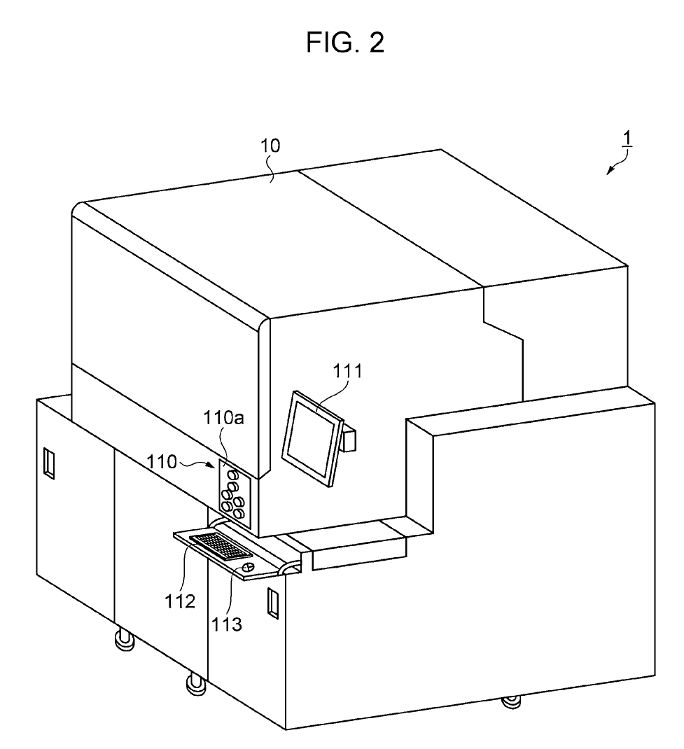

FIG. 1 is a front view schematically exemplifying a configuration of a liquid droplet discharging apparatus according to an embodiment. FIG. 2 is a perspective view exemplifying an exterior of the liquid droplet discharging apparatus. First, an outline configuration of a liquid droplet discharging apparatus 1 according to the embodiment will be described with reference to FIGS. 1 and 2. Also, in FIG. 1 or the other drawings to be described later, as needed, in order to clearly describe an arrangement relationship of each part of the apparatus, an XYZ coordinate system corresponding to a right and left direction X, a front and rear direction Y, and a vertical direction Z of the liquid droplet discharging apparatus 1 is illustrated. In addition, the liquid droplet discharging apparatus 1 of the embodiment discharges an ultraviolet ray curable ink (hereinafter, called UV ink) which is cured by being irradiated with ultraviolet rays (light).

As illustrated in FIG. 1, the liquid droplet discharging apparatus 1 is configured with a feeding section 2, a processing section 3, and a winding section 4 which are arranged in the right and left direction X. The feeding section 2 includes a feeding shaft 20, and the processing section 3 includes a rotating drum 30, and the winding section 4 includes a winding shaft 40. In the liquid droplet discharging apparatus 1, a long recording medium S in which both ends thereof are wound around the feeding shaft 20 and the winding shaft 40 in a roll shape is stretched along a transporting passage Pc. The recording medium S is transported in a transporting direction Ds in the rotating drum 30 which is provided between the feeding shaft 20 and the winding shaft 40, and an image recording is performed thereon using a head unit 3U. The types of the recording medium S are roughly divided into paper types and film types. As a specific example, there are wood free paper, cast paper, art paper, coated paper, and the like in the paper types, and synthetic paper, Polyethylene terephthalate (PET), polypropylene (PP), and the like in the film types. Also, in description hereinafter, in both surfaces of the recording medium S, one surface on which an image is recorded is referred to as a front surface, and the other surface is referred to as a rear surface.

The feeding section 2 includes the feeding shaft 20 around which one end of the recording medium S is wound, and a driven roller 21 which winds and hangs the recording medium S drawn out from the feeding shaft 20. The feeding shaft 20 supports by winding one end of the recording medium S in a state in which the front surface of the recording medium S is positioned toward the outside. Also, the feeding shaft 20 is rotated in a counterclockwise direction in FIG. 1, and thus the recording medium S wound around the feeding shaft 20 is fed to the processing section 3 via the driven roller 21. The driven roller 21 comes into contact with the recording medium S, receives a frictional force between the recording medium S and the driven roller, and is driven and rotated in the transporting direction Ds of the recording medium S. Incidentally, the recording medium S is wound around the feeding shaft 20 through a core tube which is detachable from the feeding shaft 20. Therefore, when the recording medium S of the feeding shaft 20 is exhausted, a new core tube around which the recording medium S in a roll shape is wound is mounted in the feeding shaft 20, and the recording medium S of the feeding shaft 20 can be replaced.

In the processing section 3, the recording medium S which is drawn out from the feeding section 2 is supported by the rotating drum 30, a process with respect to the recording medium S is appropriately performed by the head unit 3U disposed along an outer circumferential surface of the rotating drum 30, and an image is recorded on the recording medium S. A front driving roller 31 which transports the recording medium S to the rotating drum 30 is provided on an upstream side of the processing section 3, and a rear driving roller 32 which transports the recording medium S to the winding shaft 40 is provided on a downstream side of the processing section 3. The recording medium S which is transported from the front driving roller 31 to the rear driving roller 32 is supported by the rotating drum 30.

The front driving roller 31 includes a plurality of micro projections which are formed by thermal spraying on an outer circumferential surface, and winds and hangs the recording medium S which is drawn out from the feeding section 2 from a rear surface side. Also, when the front driving roller 31 is rotated in a clockwise direction in FIG. 1, the recording medium S which is drawn out from the feeding section 2 is transported to a downstream side of the transporting passage Pc. Also, a nip roller 31n is provided to face the front driving roller 31. The nip roller 31n comes into contact with the front surface of the recording medium S in a state of being biased to the front driving roller 31 side, and the recording medium S is pinched between the front driving roller 31 and the nip roller. Accordingly, the frictional force is secured between the front driving roller 31 and the recording medium S, and thus it is possible to reliably transport the recording medium S by the front driving roller 31.

The rotating drum 30 has a cylindrical shape including a rotating shaft 301 parallel to a Y direction, and is rotatably supported along a circumferential direction by a supporting mechanism which is not illustrated. The rotating drum 30 winds, hangs, and rotates the recording medium S which is transported from the front driving roller 31 to the rear driving roller 32 from the rear surface side. The rotating drum 30 supports the recording medium S from the rear surface side, and is driven and rotated in the transporting direction Ds of the recording medium S by receiving the frictional force between the recording medium S being transported and the rotating drum.

On the processing section 3, the driven rollers 33 and 34 which change a proceeding direction of the recording medium S are provided on both sides where the recording medium S is wound and hung around the rotating drum 30. The driven roller 33 winds and hangs the front surface of the recording medium S between the front driving roller 31 and the rotating drum 30 in the transporting direction Ds, and folds back the proceeding direction of the recording medium S to a direction toward the rotating drum 30. Meanwhile, the driven roller 34 winds and hangs the front surface of the recording medium S between the rotating drum 30 and the rear driving roller 32 in the transporting direction Ds, and folds back the proceeding direction of the recording medium S. As described above, an upstream side and a downstream side of the recording medium S in the transporting direction Ds are folded back with respect to the rotating drum 30, and thereby making it possible to secure a long winding and hanging portion of the recording medium S with respect to the rotating drum 30.

The rear driving roller 32 includes the plurality of micro projections formed by a thermal spraying on an outer circumferential surface, and winds and hangs the recording medium S transported from the rotating drum 30 via the driven roller 34 from the rear surface side. Also, when the rear driving roller 32 is rotated in a clockwise direction in FIG. 1, the recording medium S is transported to the winding section 4. Also, the nip roller 32n is provided to face the rear driving roller 32. The nip roller 32n comes into contact with the front surface of the recording medium S in a state of being biased to the rear driving roller 32 side, and the recording medium S is pinched between the rear driving roller 32 and the nip roller. Accordingly, the frictional force between the rear driving roller 32 and the recording medium S is secured, and it is possible to reliably transport the recording medium S by the rear driving roller 32.

As described above, the recording medium S which is transported from the front driving roller 31 to the rear driving roller 32 is supported on an outer circumferential surface of the rotating drum 30. Also, in order to record a color image on the front surface of the recording medium S supported by the rotating drum 30, the head unit 3U is provided. The head unit 3U is configured with heads 36a to 36e which discharge a UV ink toward the front surface of the recording medium S wound and hung along the outer circumferential surface of the rotating drum 30 and an irradiating unit which irradiates the UV ink landed on the recording medium S with ultraviolet rays, and the irradiating unit includes temporary curing irradiating units 37a and final curing irradiating units 37b. These heads 36a to 36e, the temporary curing irradiating units 37a, and the final curing irradiating units 37b are supported by a unit supporting member 35 in an arc shape along the outer circumferential surface of the rotating drum 30. Also, the head unit 3U is configured to be movable in a front and rear direction (Y direction) with respect to the rotating drum 30 by a guide mechanism 6 to be described later.

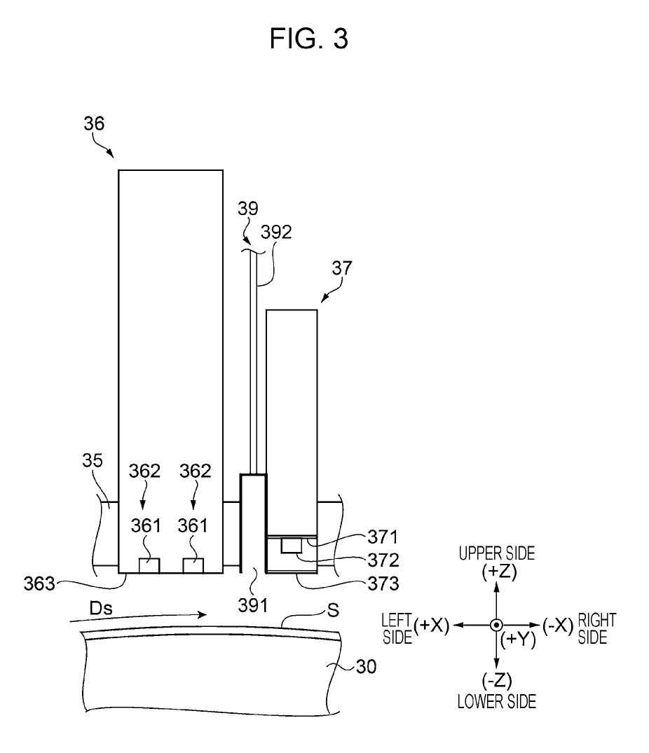

Four heads 36a to 36d which are arranged in order in the transporting direction Ds discharge UV inks corresponding, for example, cyan, magenta, black, and yellow which are different from each other from nozzles 361 (refer to FIG. 3) in an ink jet method. These four heads 36a to 36d are arranged radially from the rotating shaft 301 of the rotating drum 30, and arranged along the outer circumferential surface of the rotating drum 30. Also, a position of each of the heads 36a to 36d with respect to the rotating drum 30 is determined by the unit supporting member 35, and the heads face the rotating drum 30 with slight intervals (platen gap) with respect to the outer circumferential surface. Accordingly, each of the heads 36a to 36d are arranged in predetermined intervals with respect to the recording medium S (paper gap), and faces the front surface of the recording medium S wound and hung around the rotating drum 30. Each of the heads 36a to 36d discharges the UV ink in a state of being held with predetermined paper gaps by the unit supporting member 35, and thus the UV ink is landed on a predetermined position of the recording medium S so that a color image is formed on the front surface of the recording medium S.

The UV ink is cured by being irradiated with the ultraviolet rays from the temporary curing irradiating unit 37a for temporary curing and the final curing irradiating unit 37b for finally curing, and is fixed to the recording medium S. The temporary curing irradiating units 37a are respectively disposed between the four heads 36a to 36d. The temporary curing irradiating unit 37a cures (temporally cures) the UV ink at a degree in a state in which wet-spreading of the UV ink is sufficiently delayed by radiating the ultraviolet rays by a small irradiation amount, when compared to a case in which ultraviolet rays is not radiated, but does not finally cure the UV ink. Meanwhile, the final curing irradiating unit 37b is provided on the downstream side of the transporting direction Ds with respect to the four heads 36a to 36d. The final curing irradiating unit 37b radiates much ultraviolet rays by the irradiation amount more than that of the temporary curing irradiating unit 37a, and thus the UV ink is cured (finally cured) at a degree where wet-spreading of the UV ink is stopped.

As described above, the temporary curing irradiating units 37a disposed between each of the four heads 36a to 36d temporarily cure the UV ink which is discharged from three heads 36a to 36c to the recording medium S on the upstream side of the transporting direction Ds. For example, in the two heads 36a and 36b which are adjacent to each other, the UV ink discharged from the heads 36a to the recording medium S on the upstream side is temporarily cured during transportation of the recording medium S and reaching the recording medium to the heads 36b on the downstream side. Accordingly, generation of color mixing of which different colors of UV inks are mixed is suppressed. In a state in which the color mixing is suppressed, the four heads 36a to 36d discharge UV inks having different colors from each other, and thus a color image is formed on the recording medium S. Further, the color image formed by the four heads 36a to 36d is cured by the final curing irradiating unit 37b, which is provided on the downstream side of the transporting direction Ds nearer than the heads 36d, and is fixed to the recording medium S.

Further, the head 36e is provided on the downstream side of the transporting direction Ds with respect to the final curing irradiating unit 37b. The head 36e discharges transparent UV ink from nozzles 361 in an ink jet method. The head 36e has a position which is determined by the unit supporting member 35 with respect to the rotating drum 30, and faces the rotating drum 30 at a slight interval (platen gap) with respect to an outer circumferential surface. Accordingly, the head 36e faces the front surface of the recording medium S, which winds and hangs the rotating drum 30, with respect to the recording medium S at a predetermined interval (paper gap). Accordingly, when the head 36e discharges the UV ink in a state of being maintained at a predetermined paper gap by the unit supporting member 35, the UV ink is landed on a predetermined position of the recording medium S, and the color image on the front surface of the recording medium S is covered with the transparent UV ink. The transparent UV ink is discharged to the entire surface of the color image, and thus imparts a texture such as a gloss feeling or a mat feeling to the color image.

Such heads 36a to 36e, temporary curing irradiating units 37a, and final curing irradiating units 37b are mounted in the unit supporting member 35 so that the head unit 3U is configured. Further, in the processing section 3, a final curing irradiating unit 38, which finally cures the transparent UV ink, is provided on the downstream side of the transporting direction Ds with respect to the head 36e. The final curing irradiating unit 38 completely cures (finally cures) the transparent UV ink discharged from the head 36e by radiating strong ultraviolet rays. Accordingly, it is possible to fix the transparent UV ink covered the color image to the front surface of the recording medium S.

As described above, in the processing section 3, discharging and curing of the UV ink are appropriately performed on the recording medium S wound and hung along the outer circumferential surface of the rotating drum 30, and the color image to which the texture is imparted by the transparent UV ink is formed. Also, the recording medium S in which the color image is formed is transported to the winding section 4 by the rear driving roller 32.

The winding section 4 includes a driven roller 41 which warps the recording medium S between the winding shaft 40 and the rear driving roller 32 from the rear surface side other than the winding shaft 40 which warps the other end of the recording medium S. The winding shaft 40 winds and supports the other end of the recording medium S in a state in which the front surface of the recording medium S is toward the outside. That is, when the winding shaft 40 is rotated in a clockwise direction in FIG. 1, the recording medium S transported from the rear driving roller 32 is wound and hung around the winding shaft 40 via the driven roller 41. Incidentally, the recording medium S is wound around the winding shaft 40 through a core tube which is detachable from the winding shaft 40. Therefore, when the recording medium S wound around the winding shaft 40 is full, the recording medium S per core tube can be removed.

As illustrated in FIG. 2, the liquid droplet discharging apparatus 1 includes a case 10, and each unit of the feeding section 2, the processing section 3, and the winding section 4 as described above is accommodated inside the case 10. The case 10 prevents entering of dirt or dust to each unit inside the case 10, and thereby making it possible to secure safety of work. The case 10 is made of, for example, a plate material of stainless steel.

In addition, in the liquid droplet discharging apparatus 1, a main panel 110a including a controller 110 which controls the liquid droplet discharging apparatus 1, a monitor 111 constituted by a crystal liquid display or the like, a keyboard 112, a mouse 113, and the like are provided. Buttons and volumes included in the keyboard 112, the mouse 113, and the main panel 110a function as an input unit for inputting an input value to the controller 110. In the monitor 111, a menu screen and the like in addition to an image of an object to be printed. Therefore, a worker can input information relating to the recording medium S, the printing mode, information relating to an irradiation amount of ultraviolet rays, and the like by operating the input unit while checking the monitor 111.

Next, a configuration of peripheries of a nozzle surface of the heads will be described based on FIG. 3. FIG. 3 is an enlarged front view illustrating details of the heads and the irradiating unit. Here, the heads 36a to 36e have the same configuration as each other, and the temporary curing irradiating units 37a disposed between each of the heads 36a to 36d have the same configuration as each other. Here, in description after FIG. 3, the heads will be designated as a head 36 in a case in which the heads 36a to 36e are not particularly specified. The temporary curing irradiating units 37a will be also designated as an irradiating unit 37 in a case in which the temporary curing irradiating units are not particularly specified.

In the nozzle surface 363 of the head 36 facing the rotating drum 30, a plurality of nozzles 361 is provided. For example, in a nozzle surface 363, two nozzle rows 362 in which the nozzles 361 are arranged in a front and rear direction (Y direction) are provided in the transporting direction Ds. Also, an image is formed on the recording medium S by discharging UV ink to the recording medium S supported by the rotating drum 30 from each nozzle 361.

In addition, the irradiating unit 37 includes light emitting portions 372 disposed on a substrate 371. The light emitting portions 372 are arranged in the front and rear direction so as to make a row having almost same length as that of the nozzle row 362, and irradiate a region where an image is formed in a width direction of the recording medium S with ultraviolet rays. The ultraviolet rays are radiated from the irradiating unit 37 by applying a voltage to the light emitting portion 372, and the irradiation amount can be adjusted by controlling a voltage value to be applied to the light emitting portion 372. In addition, a glass plate 373 is provided on a surface facing the rotating drum 30, and the ultraviolet rays emitted from the light emitting portion 372 pass through the glass plate 373 and irradiate the front surface of the recording medium S. The UV ink discharged to the front surface of the recording medium S by the head 36 is cured at a speed corresponding to the irradiation amount of the ultraviolet rays.

Further, between the head 36 and the irradiating unit 37 in the transporting direction Ds, a mist suction portion 39 integrally configured with the irradiating unit 37 is provided in a state of being supported by the unit supporting member 35. A suction hole 391 of the mist suction portion 39 extends in the front and rear direction to have almost the same length as that of the nozzle row 362, and an opening surface (lower surface) of the suction hole 391 is positioned slightly upward the nozzle surface 363 of the head 36 in an up and down direction. The suction hole 391 is connected to a negative pressure generating portion which is not illustrated through a suction hose 392, a negative pressure is generated in the suction hole 391 by operating the negative pressure generating portion, and ink mist scattered in mist form in accordance with discharging of the UV ink is sucked to the suction hole 391. Therefore, attaching of the ink mist to the recording medium S or contamination of each unit inside an apparatus is suppressed.

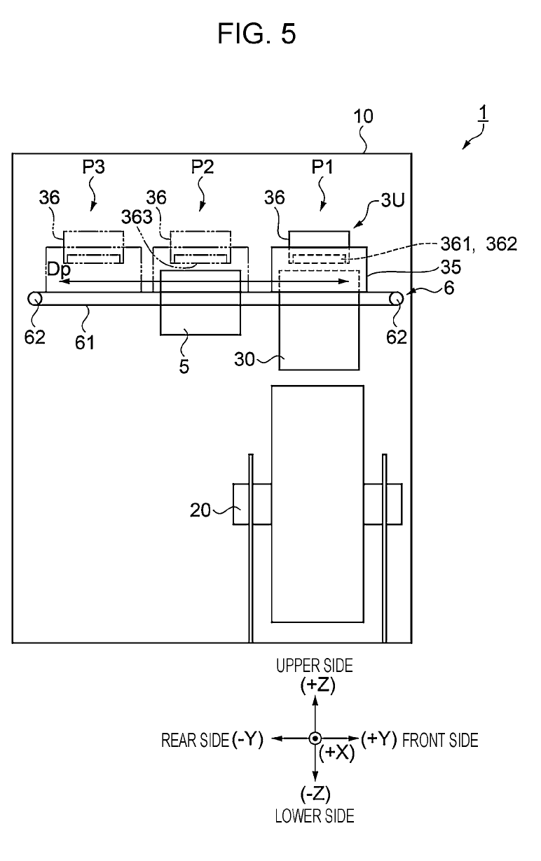

However, in a long-time printing, the ink mist (UV ink) accumulated in the nozzle surface 363 is cured by the leaked light of the ultraviolet rays which is irregularly reflected to the recording medium S or the rotating drum 30 so as to cause the discharging defect of the nozzle 361. The liquid droplet discharging apparatus 1 includes a maintenance unit 5 (refer to FIG. 5) as a cleaning unit which cleans the nozzle surface 363 of the head 36 in order to suppress such a problem.

Next, a cleaning process of the heads 36a to 36e will be described.

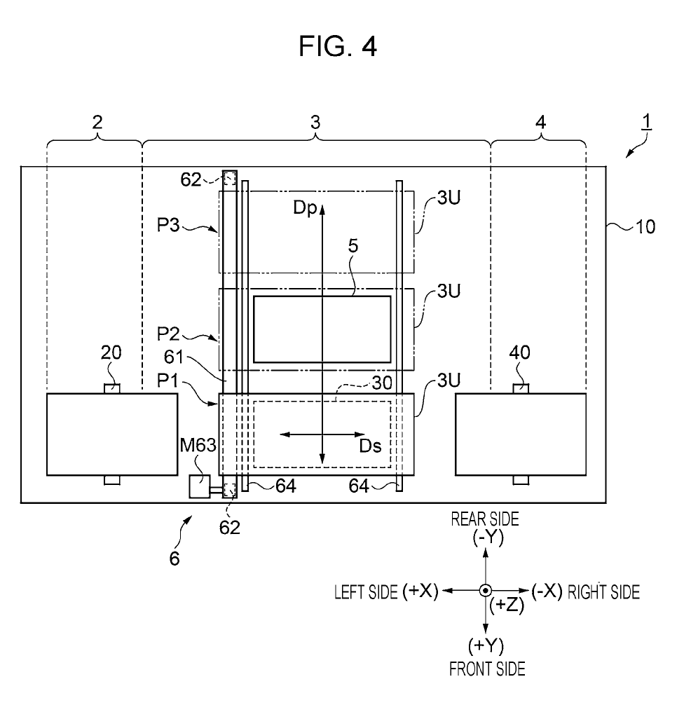

FIG. 4 is a plan view describing a movement mode of the head unit. FIG. 5 is a side view describing the movement mode of the head unit. Also, in FIGS. 4 and 5, a relationship of the head unit 3U, the rotating drum 30, and the maintenance unit 5, and a configuration of the guide mechanism 6 are illustrated, and description of other members is appropriately omitted.

The head unit 3U is configured to be movable to a cleaning position P2 and a maintenance position P3 in an orthogonal direction Dp orthogonal to the transporting direction Ds from a printing position P1 where printing is performed on the recording medium S. The cleaning position P2 faces the maintenance unit 5 and is provided at a position where the heads 36a to 36e are cleaned, and the maintenance position P3 is provided at a position where a worker performs a maintenance such as component replacement.

In the processing section 3, the guide mechanism 6 which moves the head unit 3U in the orthogonal direction Dp (Y direction) is provided. The guide mechanism 6 includes a guide belt 61 extending in the orthogonal direction Dp, a pair of pulleys 62 in which inner sides of the guide belt 61 are wound and hung up both ends of the guide belt 61 in an extending direction, a guide motor M63 rotates and drives one pulley 62 coupled with the other of the pair of pulleys 62, and a pair of right and left guide rails 64 extending in the orthogonal direction Dp. Also, a lower surface of the unit supporting member 35 of the head unit 3U is attached to the guide belt 61, and is supported by the guide rails 64 so as to be slidable on the pair of guide rails 64 in the orthogonal direction Dp.

The guide belt 61 is rotated when the guide motor M63 is driven by a control of the controller 110, and in accordance with rotation of the guide belt 61, the unit supporting member 35 moves in the orthogonal direction Dp while being supported by the pair of guide rails 64. As a result, the entire head unit 3U moves in the orthogonal direction Dp. The movement of the head unit 3U to each of positions P1, P2, and P3 can be controlled by, for example, controlling the number of times of rotation of the guide motor M63 in accordance with distances between the head unit and each position.

When the head unit 3U is positioned at the cleaning position P2, the nozzle surface 363 of each of the heads 36a to 36e faces the maintenance unit 5. The maintenance unit 5 comes into contact with the nozzle surface 363, and performs the cleaning processes of capping, cleaning, and wiping.

The capping is a process in which the nozzle 361 is covered with a cap which is not illustrated and suppresses increase of the viscosity of the UV ink inside the nozzle 361. The cleaning is a process in which the UV ink is forcibly discharged from the nozzle 361 by generating a negative pressure inside the cap in a state of being capped. Because of such a cleaning, it is possible to remove a UV ink having an increased viscosity, bubbles in the UV ink, or the like from the nozzle 361. In addition, the wiping is a process in which the nozzle surface 363 of the head 36 is wiped using a wiper which is not illustrated. Because of such a wiping, it is possible to wipe off the UV ink from the nozzle surface 363 of the head 36. Prevent or recovery of the discharging defect of the nozzle 361 can be achieved by these cleaning processes.

### Electrical Configuration

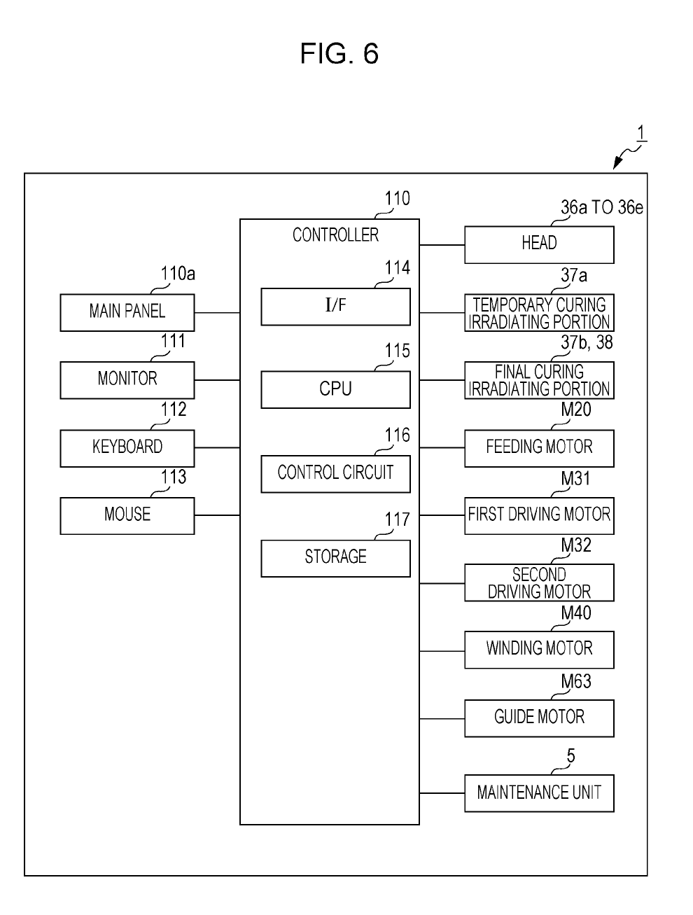

FIG. 6 is an electrical block diagram illustrating an electrical configuration of the liquid droplet discharging apparatus. Next, the electrical configuration of the liquid droplet discharging apparatus 1 will be described with reference to FIG. 6.

The liquid droplet discharging apparatus 1 includes the controller 110 which controls each unit of the liquid droplet discharging apparatus 1 in accordance with inputting from an external device or an input unit such as the main panel 110a, the keyboard 112, or the mouse 113. The controller 110 is configured with an interface unit (I/F) 114, a central processing unit (CPU) 115, a control circuit 116, and a storage 117. The interface unit 114 is used for transmitting and receiving data between an external device such as a computer or the like which handles images and the liquid droplet discharging apparatus 1. The CPU 115 is an operation processing device for controlling the entire liquid droplet discharging apparatus 1.

The storage 117 is used for securing a region where programs of the CPU 115 are stored, a work area, or the like, and includes a memory element such as a random-access memory (RAM) or an electrically erasable programmable read-only memory (EEPROM). The control circuit 116 generates a control signal for controlling each unit of the liquid droplet discharging apparatus 100.

The controller 110 controls driving of motors (feeding motor M20, first driving motor M31, second driving motor M32, and winding motor M40) respectively connected to the feeding shaft 20, the front driving roller 31, the rear driving roller 32, and the winding shaft 40 by the control signal output from the control circuit 116, and transports the recording medium S in the transporting direction Ds. In addition, the controller controls a discharging timing of the UV ink of each of the heads 36a to 36e by the control signal output from the control circuit 116, and allows the nozzle 361 of each of the heads 36a to 36e to discharge the UV ink to the recording medium S being transported to the processing section 3. Accordingly, an image or the like is formed on the recording medium S.

In addition, when each of the heads 36a to 36e is cleaned, the controller 110 controls driving of the guide motor M63 by the control signal output from the control circuit 116 and moves the head unit 3U in the orthogonal direction Dp. Also, various cleaning processes are performed by controlling each portion of the maintenance unit 5.

In addition, the controller 110 allows the monitor 111 to display an image of an object to be printed, a menu screen, and the like.

### Setting 1 of Irradiation Amount of Ultraviolet Ray and Cleaning Interval

Next, a setting method of the irradiation amount of the ultraviolet rays and the cleaning interval will be described.

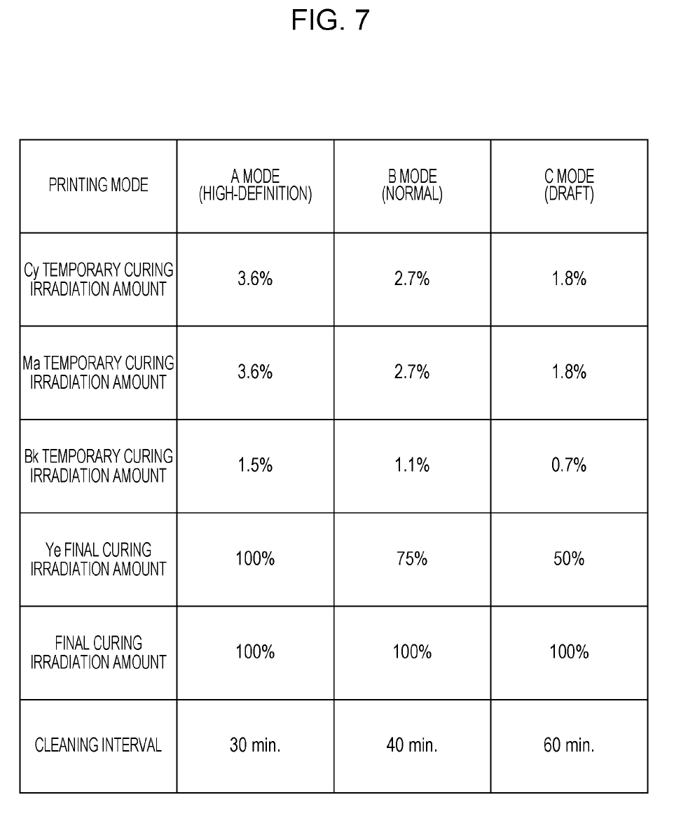

FIG. 7 is a setting table illustrating a relationship of the printing mode, the irradiation amount, and the cleaning interval.

The liquid droplet discharging apparatus 1 of the embodiment includes three printing modes of, for example, an A mode, a B mode, and a C mode as illustrated in FIG. 7, and a setting table illustrating a relationship of the irradiation amount of the ultraviolet rays and the cleaning interval, which corresponding to each mode, is stored in the storage 117 of the controller 110. Also, the A mode is prepared as a “high-definition mode” in which color mixing or spread of the colors of the UV ink is suppressed, the B mode is prepared as a “normal mode” in which an image quality and printing efficiency are balanced, and the C mode is prepared as a “draft mode” in which a priority is given to the printing efficiency.

In the setting table of FIG. 7, a Cy temporary curing irradiation amount indicates the irradiation amount of the ultraviolet rays radiated from the temporary curing irradiating unit 37a which temporarily cures a UV ink of cyan (hereinafter, also referred to as Cy ink) as a ratio (%) when the irradiation amount being radiated at the time of finally curing the UV ink per unit area is set as 100%. In the same manner, a Ma temporary curing irradiation amount indicates the irradiation amount of the ultraviolet rays radiated from the temporary curing irradiating unit 37a which temporarily cures a UV ink of magenta (hereinafter, also referred to as Ma ink), and a Bk temporary curing irradiation amount indicates the irradiation amount of the ultraviolet rays radiated from the temporary curing irradiating unit 37a which temporarily cures a UV ink of black (hereinafter, also referred to as Bk ink). In addition, a Ye final curing irradiation amount indicates the irradiation amount of the ultraviolet rays radiated from the final curing irradiating unit 37b which further cures the UV ink having each color after a UV ink of yellow (hereinafter, also referred to as Ye ink) is discharged. A final curing irradiation amount is an irradiation amount of the ultraviolet rays radiated from the final curing irradiating unit 38 which finally cures a transparent UV ink.

In addition, the cleaning interval indicates an interval at which the cleaning process is performed on the nozzle surface 363 of the head 36 by the maintenance unit 5. For example, it means that, in the A mode, the nozzle surface 363 is cleaned for every 30 minutes taken for performing a continuous printing.

When the first mode, in which the irradiation amount of the ultraviolet rays of the temporary curing irradiating unit 37a as an irradiating unit with respect to the unit printing area is set as the first amount, is performed, the controller 110 sets the cleaning interval of the nozzle surface 363 by the maintenance unit 5 as a cleaning unit as the first interval. In detail, in a case in which the A mode is selected from a printing mode selecting screen displayed on the monitor 111 as the first mode by a worker, the controller 110 sets the irradiation amount of the ultraviolet rays radiated from the temporary curing irradiating unit 37a as the first amount with reference to an A mode row of the setting table illustrated in FIG. 7. Specifically, the controller 110 sets the first amount (Cy and Ma temporary curing irradiation amounts) of the temporary curing irradiating unit 37a which temporarily cures the Cy ink and the Ma ink to 3.6% of the final curing irradiation amount, and sets the first amount (Bk temporary curing irradiation amount) of the temporary curing irradiating unit 37a which temporarily cures the Bk ink as 1.5% of the final curing irradiation amount. Also, the irradiation amounts (Ye final curing irradiation amount and final curing irradiation amount) of the final curing irradiating units 37b and 38 are set to 100%. In this embodiment, the irradiation amount of the temporary curing irradiating unit with respect to the unit printing area is the same as an illumination intensity of the ultraviolet rays with which the irradiating unit irradiates the front surface of the recording medium S positioned at a position facing the irradiating unit.

Further, the controller 110 sets the first interval, which is a cleaning interval of the nozzle surface 363 when printing in the A mode set as the first amount is performed, to 30 minutes. In the printing in the A mode, the continuous printing in which generation of the discharging defect of the nozzle 361 is suppressed is performed by cleaning the nozzle surface 363 at a frequency of 30 minutes per one time.

In addition, when the second mode, in which the irradiation amount of the ultraviolet rays of the temporary curing irradiating unit 37a as the irradiating unit with respect to the unit printing area is set as the second amount smaller than the first amount, is performed, the controller 110 sets the cleaning interval of the nozzle surface 363 by the maintenance unit 5 as the cleaning unit as the second interval longer than the first interval. In detail, in a case in which the B mode is selected from the printing mode selecting screen displayed on the monitor 111 as the second mode by a worker, the controller 110 sets the irradiation amount of the ultraviolet rays radiated from the temporary curing irradiating unit 37a as the second amount smaller than the first amount in the A mode with reference to the B mode of the setting table illustrated in FIG. 7. Specifically, the second amounts (Cy and Ma temporary curing irradiation amounts) of the temporary curing irradiating units 37a which temporarily cure the Cy ink and the Ma ink are set to 2.7% of the final curing irradiation amount, and the second amount (Bk temporary curing irradiation amount) of the temporary curing irradiating unit 37a which temporarily cures the Bk ink is set to 1.1% of the final curing irradiation amount. Also, the irradiation amount (Ye final curing irradiation amount) of the final curing irradiating unit 37b is also set to 75% which is smaller than that in the A mode. In addition, the irradiation amount (final curing irradiation amount) of the final curing irradiating unit 38 is set to 100%.

In a case of the B mode, since the irradiation amount of the ultraviolet rays (second amount) of the temporary curing irradiating unit 37a is smaller than the first amount in the A mode, the irradiation amount for irradiating the nozzle surface 363 when the leaked light of the ultraviolet rays radiated from the temporary curing irradiating unit 37a reaches the nozzle surface 363 is also reduced. Accordingly, since a time taken until the UV ink attached to the nozzle surface 363 is cured so as to cause the discharging defect of the nozzle 361 is also longer, the controller 110 sets the cleaning interval of the B mode to 40 minutes (second interval) longer than the cleaning interval of the A mode with reference to the setting table illustrated in FIG. 7.

In the setting table, a product of the irradiation amount (first amount) of the temporary curing irradiating unit 37a and the cleaning interval (first interval) in the A mode is set to be equal to a product of the irradiation amount (second amount) of the temporary curing irradiating unit 37a and the cleaning interval (second interval) in the B mode. The product of the irradiation amount and the cleaning interval is an accumulated light amount of the ultraviolet rays radiated from the temporary curing irradiating unit 37a until the cleaning is performed. That is, the cleaning interval (second interval) in the B mode is set so that the accumulated light amounts in the A mode and the B mode are same as each other. In other words, since the accumulated light amount of the leaked light being reach the nozzle surface 363 in each mode is the same as the other, in a case in which printing is performed by the second amount with the second interval in the B mode, it is possible to reduce the number of times of cleaning while maintaining the probability of generation (frequency) of the discharging defect of the nozzle 361 caused by curing the UV ink to be equal to the probability of generation when printing is performed by the first amount with the first interval in the A mode.

Also, even in a case in which the C mode is selected, the irradiation amounts and the cleaning intervals of the temporary curing irradiating units 37a and the final curing irradiating units 37b and 38 are set in the same manner as described above. In the C mode, since an irradiation amount is set as an irradiation amount much smaller than the irradiation amount in the B mode, and a cleaning interval is set as a cleaning interval much longer than the cleaning interval in the B mode, it is possible to further reduce the number of times of cleaning while maintaining probability of generation (frequency) of the discharging defect to be equal to those of in the A mode and the B mode.

### Setting 2 of Irradiation Amount of Ultraviolet Rays and Cleaning Interval

The liquid droplet discharging apparatus 1 of the embodiment is also capable of changing the irradiation amount of the ultraviolet rays to a predetermined amount depending on a volume of the main panel 110a or an input value from the input unit of the keyboard 112.

The controller 110 sets the irradiation amount of the ultraviolet rays by the temporary curing irradiating unit 37a as the irradiating unit based on the input value through the input unit, and sets the cleaning interval of the nozzle surface 363 by the maintenance unit 5 as the first interval when the irradiation amount of the ultraviolet rays of the temporary curing irradiating unit 37a with respect to the unit printing area is set as the first amount. In detail, a worker inputs an input value from the input unit indicating the irradiation amount of the ultraviolet rays from the volume of the main panel 110a or the keyboard 112 as the input unit. The input value which is input may be a number indicating the irradiation amount, or may be a ratio with respect to the maximum irradiation amount (final curing irradiation amount). The controller 110 sets the irradiation amount of the ultraviolet rays radiated from the temporary curing irradiating unit 37a as the first amount based on the input value. As the input value, in a case in which a ratio with respect to the maximum irradiation amount is input, in accordance with the ratio, the controller 110 sets the first amount of the temporary curing irradiating unit 37a which temporarily cures, for example, the Cy ink and Ma ink to 3.6% of the maximum irradiation amount, and sets the first amount of the temporary curing irradiating unit 37a which temporarily cures the Bk ink to 1.5% of the maximum irradiation amount.

Further, the controller 110 sets the first interval, which is the cleaning interval of the nozzle surface 363 when the printing is performed by the first amount, to 30 minutes, when the continuous printing in which generation of the discharging defect of the nozzle 361 is suppressed is possible.

In addition, the controller 110 sets the cleaning interval of the nozzle surface 363 by the maintenance unit 5 as the cleaning unit to the second interval longer than the first interval, when the irradiation amount of the ultraviolet rays of by the temporary curing irradiating unit 37a as the irradiating unit with respect to the unit printing area is set as the second amount smaller than the first amount. In detail, in a case in which the worker inputs the irradiation amount of the ultraviolet rays smaller than the first amount from the volume of the main panel 110a or the keyboard 112 as the input unit, the controller 110 sets the irradiation amount of the ultraviolet rays radiated from the temporary curing irradiating unit 37a as the second amount based on the input value. The controller 110 sets the second amount of the temporary curing irradiating unit 37a which temporarily cures, for example, the Cy ink and Ma ink to 2.7% of the maximum irradiation amount smaller than the first amount, and sets the second amount of the temporary curing irradiating unit 37a which temporarily cures the Bk ink to 1.1% of the maximum irradiation amount smaller than the first amount.

Also, the controller 110 sets the cleaning interval based on the irradiation amount of the temporary curing irradiating unit 37a with respect to the unit printing area. The controller 110 calculates the second interval so that the product of the irradiation amount of the temporary curing irradiating unit 37a (first amount) and the cleaning interval (first interval) is equal to the product of the irradiation amount of the temporary curing irradiating unit 37a (second amount) and the cleaning interval (second interval).

Specifically, the controller 110 calculates the second interval using the following equation, and sets the cleaning interval, when the irradiation amount of the ultraviolet rays is set as the second amount, to 40 minutes (second interval).

3.6% (first amount)×30 minutes (first interval)/2.7% (second amount)=40 minutes (second interval)

The product of the irradiation amount and the cleaning interval is the accumulated light amount of the ultraviolet rays being radiated from the temporary curing irradiating unit 37a until the cleaning is performed. Since the accumulated light amount of the first amount and the first interval is equal to the accumulated light amount of the second amount and the second interval, the accumulated light amount of the leaked light reaching the nozzle surface 363 is also same. Therefore, in a case in which printing is performed by the second amount with the second interval, it is possible to reduce the number of times of cleaning while maintaining probability of generation (frequency) of the discharging defect of the nozzle 361 generated by curing the UV ink attached to the nozzle surface 363 to be equal to probability of generation when the printing is performed by the first amount with the first interval. In addition, since the controller 110 sets the cleaning interval based on the irradiation amount of the temporary curing irradiating unit 37a, which is disposed close to between the heads 36a to 36e, with respect to the unit area, an appropriate second interval can be obtained.

Also, even in a case in which “equal” or “same” is disclosed in this specification, these do not mean only exact match, but may include errors within a range where an effect of the invention is exerted.

In addition, the invention is not limited to the above described embodiment, and various modifications with respect to the above described embodiment can be made without departing from the gist thereof. In the embodiment described above, a case in which the invention is applied to the liquid droplet discharging apparatus 1 in which the recording medium S is supported by the cylindrical rotating drum 30 is exemplified, but this configuration in which the recording medium S is supported is not limited thereto. For example, a liquid droplet discharging apparatus which has a configuration in which the recording medium S is supported in flat may be used.

In addition, the numbers, arrangements, colors to be discharged, and the like of the heads 36a to 36e can be also appropriately changed. The numbers, arrangements, and the like of the temporary curing irradiating units 37a and the final curing irradiating units 37b and 38 can be also appropriately changed. Further, a transportation mode of the recording medium S can be also appropriately changed. In addition, a receiving unit which receives an input value transmitted from an external device and inputs the value to the controller 110 may be included, instead of the input unit for inputting the input value to the controller 110. In addition, the storage 117 includes a table in association with a relationship of the types of the recording medium S according to the wettability of the recording medium S and the printing mode (cleaning interval), and the printing mode may be automatically determined according to the types of the recording medium S. For example, the recording medium with high wettability associates with the printing mode having a short cleaning interval more than the recording medium with low wettability. This is because, since ink landed on the recording medium with high wettability is easier to color-mix than the recording medium with low wettability, in order to prevent the color mixing of the ink, the irradiation amount of the ultraviolet rays is set to be great than that in a case in which the recording medium with low wettability is used.

As described above, according to the liquid droplet discharging apparatus 1 of the embodiment, effects as follows can be obtained.

The controller 110 of the liquid droplet discharging apparatus 1 sets the cleaning interval of the nozzle surface 363 as the second interval smaller than the first interval of the first mode, when printing is performed in the second mode in which the irradiation amount of the ultraviolet rays radiated from the temporary curing irradiating unit 37a is the second amount smaller than the first amount of the first mode. Since the second interval of the second mode is set so that the product of the first amount and the first interval is equal to the product of the second amount and the second interval, the accumulated light amounts of the leaked light reaching the nozzle surface 363 in the first mode and the second mode before cleaning is performed are the same as each other. Accordingly, in a case in which printing is performed by the second amount with the second interval of the second mode, it is possible to reduce the number of times of cleaning while maintaining probability of generation (frequency) of the discharging defect of the nozzle 361 generated by curing the UV ink to be equal to probability of generation when printing is performed by the first amount with the first interval of the first mode. Therefore, it is possible to improve the production efficiency of the liquid droplet discharging apparatus 1.

The controller 110 of the liquid droplet discharging apparatus 1 sets the cleaning interval of the nozzle surface 363 as the second interval longer than the first interval when printing is performed by the first amount, when printing is performed by the second amount of the irradiation amount of the ultraviolet rays smaller than the first amount, based on the input value through the volume of the main panel 110a or the keyboard 112 as the input unit. Since the second interval is set so that the product of the first amount and the first interval is equal to the product of the second amount and the second interval, the accumulated light amounts of the leaked light reaching the nozzle surface 363 in the printing by the first amount with the first interval and the printing by the second amount with the second interval until the cleaning is performed are the same as each other. Accordingly, in a case in which the printing is performed by the second amount with the second interval, it is possible to reduce the number of times of cleaning while maintaining probability of generation (frequency) of the discharging defect of the nozzle 361 generated by curing the UV ink to be equal to probability of generation when the printing is performed by the first amount with the first interval of the first mode. Therefore, it is possible to improve the production efficiency of the liquid droplet discharging apparatus 1.

In addition, since the controller 110 sets the cleaning interval based on the irradiation amount of the temporary curing irradiating unit 37a, which is disposed close to between the heads 36a to 36d, with respect to the unit area, it is possible to obtain an appropriate second interval.

This application claims priority under 35 U.S.C. § 119 to Japanese Patent Application No. 2017-092817, filed May 9 2017. The entire disclosure of Japanese Patent Application No. 2017-092817 is hereby incorporated herein by reference.

What is claimed is:

1. A liquid droplet discharging apparatus comprising:
a head that discharges an ultraviolet ray curable ink;
an irradiating unit that irradiates the ultraviolet ray curable ink landed on a recording medium with ultraviolet rays;
a cleaning unit that cleans a nozzle surface of the head; and
a controller,
wherein the controller
sets a cleaning interval of the cleaning unit with respect to the nozzle surface as a first interval when a first mode, in which an irradiation amount of the ultraviolet rays of the irradiating unit with respect to a unit printing area is set as a first amount, is performed, and
sets the cleaning interval of the cleaning unit with respect to the nozzle surface as a second interval which is longer than the first interval when a second mode, in which the irradiation amount of the ultraviolet rays of the irradiating unit with respect to the unit printing area is set as a second amount which is smaller than the first amount, is performed.

2. A liquid droplet discharging apparatus comprising:
a head that discharges an ultraviolet ray curable ink;
an irradiating unit that irradiates the ultraviolet ray curable ink landed on a recording medium with ultraviolet rays;
a cleaning unit that cleans a nozzle surface of the head;
an input unit; and
a controller,
wherein the controller
sets an irradiation amount of the ultraviolet rays by the irradiating unit based on an input value which is input through the input unit,
sets a cleaning interval of the cleaning unit with respect to the nozzle surface as a first interval when the irradiation amount of the ultraviolet rays of the irradiating unit with respect to the unit printing area is set as a first amount, and
sets the cleaning interval of the cleaning unit with respect to the nozzle surface as a second interval which is longer than the first interval when the irradiation amount of the ultraviolet rays of the irradiating unit with respect to the unit printing area is set as a second amount which is smaller than the first amount.

3. The liquid droplet discharging apparatus according to claim 1,
wherein a product of the first amount and the first interval is equal to a product of the second amount and the second interval.

4. The liquid droplet discharging apparatus according to claim 1,
wherein the irradiating unit includes a temporary curing irradiating unit and a final curing irradiating unit, and
wherein the controller sets the cleaning interval based on the irradiation amount of the temporary curing irradiating unit with respect to the unit printing area.
